(19) United States
(12) Patent Application Publication
(10) Pub. No.: US 2025/0302697 A1
(43) Pub. Date: Oct. 2, 2025

(54) SEALED MEDICATION CRUSHER WITH DIRECT ENTERAL ADMINISTRATION AND CONTAMINATION PREVENTION

(71) Applicant: Francis Palma Fabrigas, San Antonio, TX (US)

(72) Inventor: Francis Palma Fabrigas, San Antonio, TX (US)

(21) Appl. No.: 19/087,647

(22) Filed: Mar. 24, 2025

Related U.S. Application Data
(60) Provisional application No. 63/572,845, filed on Apr. 1, 2024.

(51) Int. Cl. A61J 3/00; A61J 3/02

(52) U.S. Cl. CPC A61J 3/002; A61J 3/02; A61J 2200/70

(57) ABSTRACT

In the present invention, a sealed medication crushing and delivery system for enteral administration is disclosed. The system includes a crusher assembly with a lid, syringe-connectable inlet, enteral tube-connectable discharge outlet, sealed crushing chamber, and motor-driven crushing mechanism. A motor assembly provides controlled rotational power, ensuring efficient pulverization of solid medications into fine particles for enteral delivery. The sealed system prevents airborne particulate release, reducing medication loss and contamination risks. A fluid coupling system allows liquid introduction while maintaining a closed environment, ensuring complete dissolution and uniform mixing. A safety interlock mechanism prevents accidental activation by ensuring proper system engagement. The discharge outlet directly connects to an enteral syringe or tube, eliminating manual transfers. An embodiment includes a manually operable plunger for precise medication expulsion. The system may also feature a vented lid, LED status indicator, and filtering mechanism, ensuring safe and efficient medication preparation.

### CROSS-REFERENCE TO RELATED APPLICATIONS

This application contains subject matter which is related to the subject matter of the following co-pending application. The below-listed application is hereby incorporated herein by reference in its entirety:

This is a U.S. non-provisional application that claims the benefit of a U.S. provisional patent application, Ser. No. 63/572,845, inventor Francis Fabrigas, entitled “MEDICATION CRUSHING AND DELIVERY SYSTEM AND METHOD OF USE”, filed Apr. 1, 2024.

### TECHNICAL FIELD OF THE INVENTION

The present invention relates to medication preparation and delivery systems, specifically to a sealed, motorized medication crushing and dispensing system for enteral administration. The invention provides an efficient, contamination-free, and user-friendly solution for crushing, mixing, and delivering solid medications in a liquid suspension through an enteral tube.

### BACKGROUND OF THE INVENTION

Before our invention, healthcare providers and caregivers relied on manual medication crushing methods to prepare medications for enteral administration. These methods included pill crushers, mortar-and-pestle grinding, mechanical grinders, and pouch-based crushing systems. While these approaches allowed medications to be pulverized and mixed with a liquid for tube feeding, they introduced a range of shortcomings that compromised safety, efficiency, and accuracy in medication delivery.

A major shortcoming of existing medication crushing systems is the release of airborne drug particulates during the crushing process. When medications are manually crushed, fine drug dust escapes into the air, exposing healthcare workers, caregivers, and nearby individuals to hazardous pharmaceutical particulates. This exposure is particularly concerning in hospital and long-term care settings, where repeated inhalation of potent, cytotoxic, or highly concentrated drugs can lead to adverse health effects.

Another shortcoming of prior methods is medication loss and underdosing, which occurs due to residue left behind in crushing devices and the need for multiple transfers between containers. Many traditional crushing techniques require users to first crush the medication in one device, then transfer the crushed medication into a separate mixing container, and finally transfer the mixed solution into an enteral syringe for administration. Each transfer introduces residue loss, leading to incomplete dosing and potential variations in medication effectiveness.

Clogging of enteral tubes is another critical shortcoming. Traditional crushing methods do not always achieve uniform particle size, resulting in large, uneven fragments that can obstruct an enteral feeding tube. Clogged tubes require manual flushing, which adds unnecessary steps, delays medication delivery, and creates additional work for caregivers and nurses.

Existing manual crushing techniques also have the shortcoming of requiring significant physical effort and time. Crushing hard tablets or multiple medications can be labor-intensive, particularly for elderly caregivers or individuals with limited hand strength or dexterity. The manual effort involved in grinding medications can be time-consuming, impacting workflow efficiency in clinical settings where speed and accuracy are essential.

Another notable shortcoming is the risk of cross-contamination. Many traditional crushing devices are difficult to clean, and residual drug particles from previous medication preparations can carry over to subsequent doses, posing a risk to patients with allergies, drug sensitivities, or strict dosage requirements. Additionally, some crushing methods involve open containers, further increasing the likelihood of environmental contamination and hygiene concerns.

The present invention addresses these and other shortcomings by providing a sealed, motorized medication crushing and delivery system that enables efficient, contamination-free, and controlled medication preparation for enteral administration. For these reasons and shortcomings, as well as other reasons and shortcomings, there is a long-felt need that gives rise to the present invention.

### SUMMARY OF THE INVENTION

The shortcomings of the prior art are overcome and additional advantages are provided through the provision of a sealed medication crushing and delivery system for enteral administration. The system includes a crusher assembly comprising a lid with a syringe-connectable inlet and an enteral tube-connectable discharge outlet, a crusher body forming a sealed crushing chamber to contain medications, and a base housing a crushing mechanism designed to pulverize solid medications. A motor assembly is configured to engage with the crusher assembly, providing rotational power to the crushing mechanism, enabling efficient and uniform pulverization of medication. The crusher body, lid, and base together form a sealed containment system, preventing the release of airborne particulates during the crushing process, thereby minimizing medication loss and exposure risks. The system further includes a enteral tube-connectable discharge outlet that provides a direct medication transfer pathway, allowing for seamless administration of the pulverized medication through an enteral tube without requiring intermediate transfers, ensuring precise dosing, reduced contamination risk, and improved ease of use in clinical and home healthcare settings.

Additional shortcomings of the prior art are overcome and additional advantages are provided through the provision of a sealed medication crushing and delivery system for enteral administration. The system includes a housing that defines a crushing chamber, which is equipped with an input port configured to receive enteral syringe and liquid for dissolution and mixing. A motor-driven crushing mechanism is disposed within the chamber, designed to pulverize solid medications into fine particles suitable for enteral administration. A motor unit is operably coupled to the crushing mechanism, providing controlled rotational power to ensure consistent and effective medication crushing. The system further includes an output port that allows for direct connection to an enteral tube, enabling seamless transfer of the crushed medication mixture without requiring intermediate handling, thereby reducing contamination risks and medication loss. Additionally, a safety interlock mechanism ensures that the crushing mechanism operates only when the device is properly engaged, preventing accidental activation and enhancing user safety in clinical and home healthcare environments.

Additional shortcomings of the prior art are overcome and additional advantages are provided through the provision of a sealed medication crushing and delivery system for enteral administration. The system includes a crusher assembly with a sealed containment chamber, which features an entry port for introducing solid medication and a discharge port for delivering a liquid medication mixture. A motor-driven rotatable blade assembly is positioned within the chamber and configured to crush and mix the medication, ensuring uniform particle size and thorough dissolution. The system further includes a motorized base that is removably attachable to the containment chamber, providing controlled rotational power to the blade assembly while allowing for modular operation and easy cleaning. A fluid coupling system is integrated into the design, enabling the introduction of liquid through the entry port while maintaining a fully enclosed environment, preventing contamination and medication loss. A locking mechanism ensures secure attachment of the chamber to the motorized base, preventing operation unless properly engaged, thereby enhancing safety and reliability. Additionally, a manually operable plunger is provided to expel the prepared medication mixture through the discharge port, ensuring precise dosing and direct administration through an enteral tube, minimizing handling steps and reducing the risk of cross-contamination.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE FIGURES

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a perspective view of the assembled sealed medication crushing and delivery system for enteral administration;

FIG. 2 illustrates one example of a perspective view of the main components of the sealed medication crushing and delivery system for enteral administration in an uncoupled configuration;

FIG. 3 illustrates one example of a disassembled view of the crushing housing assembly of the sealed medication crushing and delivery system for enteral administration assembly;

FIG. 4 illustrates one example of a front view of the crushing housing assembly of the sealed medication crushing and delivery system for enteral administration;

FIG. 5 illustrates one example of a left side view of the crushing housing assembly of the sealed medication crushing and delivery system for enteral administration;

FIG. 6 illustrates one example of a top view of of the crushing housing assembly of the sealed medication crushing and delivery system for enteral administration;

FIG. 7 illustrates one example of a bottom view of the crushing housing assembly of the sealed medication crushing and delivery system for enteral administration;

FIG. 8 illustrates one example of a disassembled view of the motor assembly of the sealed medication crushing and delivery system for enteral administration;

FIG. 9 illustrates one example of a front view of the motor assembly of the sealed medication crushing and delivery system for enteral administration;

FIG. 10 illustrates one example of a right side view of the motor assembly of the sealed medication crushing and delivery system for enteral administration;

FIG. 11 illustrates one example of a top view of the motor assembly of the sealed medication crushing and delivery system for enteral administration;

FIG. 12 illustrates one example of a bottom view of the motor assembly of the sealed medication crushing and delivery system for enteral administration;

FIG. 13 illustrates one example of a perspective view of an enteral syringe;

FIG. 14 illustrates one example of a bottom perspective view of the base of the crushing housing assembly of the sealed medication crushing and delivery system;

FIG. 15 illustrates one example of a close-up top perspective view of the upper portion of the motor assembly of the sealed medication crushing and delivery system for enteral administration;

FIG. 16 illustrates one example of a close-up view of the crushing housing assembly of the sealed medication crushing and delivery system, containing pills and is coupled to an enteral syringe and uncoupled from the motor assembly;

FIG. 17 illustrates one example of a perspective view of the sealed medication crushing and delivery system assembly, containing a mixture of pulverized medications, coupled to an enteral syringe and an enteral tube;

FIG. 18 illustrates one example of a perspective view of the motor unit of the present disclosure uncoupled to a charging dock;

FIG. 19 illustrates one example of a front perspective view of another embodiment of the crushing housing assembly of the sealed medication crushing and delivery system;

FIG. 20 illustrates a technician using the sealed medication crushing and delivery system;

FIG. 21 illustrates one example of how the sealed medication crushing and delivery system motor assembly is integrated into an enteral feeding pump with the crushing housing assembly attached to an enteral syringe and is disengaged from the engaging mechanism of the motor assembly;

FIG. 22 illustrates one example of the sealed medication crushing and delivery system integrated into an enteral feeding pump with the crushing housing assembly and the motor housing engaged;

FIG. 23 illustrates one example of how the sealed medication crushing and delivery system can be integrated into an enteral feeding pump and how it is connected to the enteral feeding tubing system;

FIG. 24 illustrates one example of a front view of an alternative embodiment, of the sealed medication crushing and delivery system with the first main body in a retracted position;

FIG. 25 illustrates one example of a cross-sectional view of an alternative embodiment of the sealed medication crushing and delivery system;

FIG. 26 illustrates one example of an alternative embodiment of the sealed medication crushing and delivery system containing a tablet with the first main body in a depressed position;

FIG. 27 illustrates one example of the top view of an alternative embodiment of the sealed medication crushing and delivery system;

FIG. 28 illustrates one example of a bottom view of the sealed medication crushing and delivery system;

FIG. 29 illustrates one example of a top perspective view of an alternative embodiment of the sealed medication crushing and delivery system;

FIG. 30 illustrates one example of an disassembled view of an alternative embodiment of the sealed medication crushing and delivery system;

FIG. 31 illustrates one example of a front view of an alternative embodiment of the sealed medication crushing and delivery system connected to an enteral syringe and an enteral tube;

FIG. 32 illustrates one example of a cross-sectional view of an embodiment of the sealed medication crushing and delivery system connected to an enteral syringe and an enteral tube;

FIG. 33 illustrates one example of an embodiment of the sealed medication crushing and delivery system; and

FIG. 34 illustrates one example of a cross-sectional view of an embodiment of the sealed medication crushing and delivery system.

The detailed description explains the preferred embodiments of the invention, together with advantages and features, by way of example with reference to the drawings.

### DETAILED DESCRIPTION OF THE INVENTION

The present invention provides a sealed, motorized medication crushing and delivery system that ensures efficient, contamination-free, and user-friendly medication preparation for enteral administration. This system is designed to address the challenges of medication pulverization and delivery by integrating a sealed containment chamber, a motorized crushing mechanism, and a direct medication transfer pathway into a single device. Unlike prior approaches that required multiple transfers, manual effort, and exposed users to airborne particulates, this invention automates and streamlines the entire process within a closed, hygienic environment.

The system features a crusher assembly with a sealed chamber that prevents medication particulates from escaping into the surrounding environment during pulverization. The motor-driven crushing mechanism ensures that solid medications are evenly and completely pulverized, reducing the risk of enteral tube clogging and incomplete dissolution. The direct medication transfer pathway, facilitated by an enteral syringe-compatible inlet and an outlet configured for direct tube delivery, eliminates the need for multiple containers and reduces medication loss.

The present invention is designed for ease of use, incorporating a motorized base with a safety interlock mechanism that ensures the crushing process can only be activated when the components are properly engaged. This minimizes user effort and enhances operational safety by preventing accidental activation. The system is also designed for quick disassembly and cleaning, reducing the risk of cross-contamination and ensuring compliance with clinical hygiene standards.

By combining automated crushing, sealed containment, direct enteral administration, and integrated safety features, this invention provides an efficient and reliable solution for clinicians, caregivers, and patients. The system allows for precise dosing, reduced preparation time, and enhanced safety, making it ideal for use in hospitals, long-term care facilities, and home healthcare settings.

In the context of the present invention, a fluid coupling system refers to a sealed fluid transfer mechanism integrated into the medication crushing and delivery system to enable the controlled introduction of liquid into the crushing chamber while maintaining a closed environment. The fluid coupling system may comprise an inlet port, a syringe-compatible connection, a one-way valve, or a sealed passageway, configured to allow precise liquid dosing for dissolution, suspension, or mixing of the pulverized medication. The system is designed to prevent leakage, minimize contamination risks, and ensure uniform distribution of liquid within the chamber, facilitating seamless enteral administration. In certain embodiments, the fluid coupling system may also include pressure-equalizing features to regulate internal chamber conditions, ensuring consistent mixing and flow dynamics of the liquid-medication mixture.

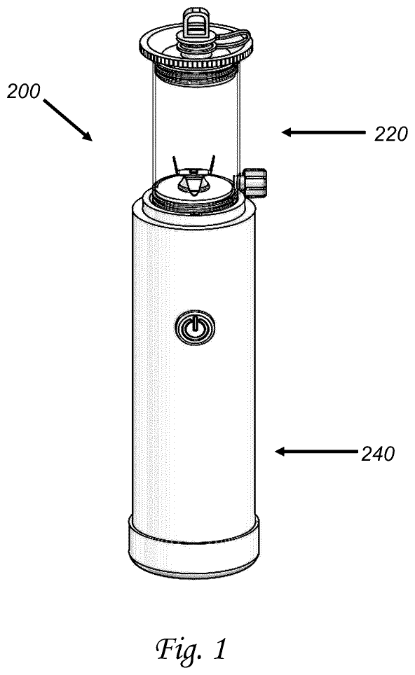

Turning now to the drawings in greater detail, it will be seen that in FIG. 1 there is illustrated one example of a sealed medication crushing and delivery system for enteral administration 200 in an assembled configuration. In an exemplary embodiment, the system 200 includes a crusher assembly 220 and a motor assembly 240. The crusher assembly 220 forms a sealed containment chamber that is configured to receive and pulverize solid medications while preventing the release of airborne particulates. The motor assembly 240 is configured to engage with the crusher assembly 220 to provide rotational power for the crushing mechanism disposed within the system 200. The system 200 is designed to connect to an enteral syringe and an enteral tube, enabling direct administration of a medication mixture without the need for multiple transfers, thereby reducing medication loss and contamination risks.

The crusher assembly 220 includes a lid 220a, a crusher body 220b, and a base 220c. In an exemplary embodiment, the lid 220a is configured to securely attach to the crusher body 220b, forming a sealed enclosure that prevents medication particulates from escaping during the crushing process. The lid 220a includes a syringe-connectable inlet 222, which allows for the introduction of a liquid solvent or diluent, and a discharge outlet 228, which is configured to allow direct medication transfer into an enteral tube. The base 220c houses a motor-driven crushing mechanism 232 that is designed to pulverize solid medications into fine particles, ensuring uniform mixing and proper dissolution when combined with liquid.

In an exemplary embodiment, a sealed medication crushing and delivery system for enteral administration 200 is provided. The system 200 includes a crusher assembly 220 comprising a lid 220a with a syringe-connectable inlet 222 and a discharge outlet 228, a crusher body 220b forming a sealed crushing chamber 227 for containing medications, and a base 220c housing a crushing mechanism 232 configured to pulverize solid medications. A motor assembly 240 is designed to engage with the crusher assembly 220 and provide rotational power to the crushing mechanism 232. The crusher body 220b, lid 220a, and base 220c together form a sealed containment system, preventing the release of airborne particulates during the medication crushing process. The discharge outlet 228 allows for direct medication transfer into an enteral tube without requiring intermediate transfers, minimizing medication loss and contamination.

In an exemplary embodiment, the crushing mechanism 232 within the sealed crushing chamber 227 comprises a set of rotating blades 250 designed to crush, pulverize, and mix solid medications 252, ensuring uniform particle size and dissolution efficiency before administration.

In an exemplary embodiment, the discharge outlet 228 is ENFit-compatible, allowing for secure and standardized connection with an enteral connector or enteral tube, ensuring leak-proof medication delivery while preventing misconnections with non-enteral devices.

In an exemplary embodiment, the motor assembly 240 is powered by a rechargeable battery 246a-b, allowing for cordless operation and portability, making the system suitable for various healthcare environments, including hospitals, long-term care facilities, and home healthcare settings.

In an exemplary embodiment, the motor assembly 240 further comprises a pressure-sensitive activation switch 274 integrated with the locking slots 243a and 243b ensuring that the motor is only engaged when the crusher assembly 220 is properly secured. This safety interlock mechanism prevents accidental operation and ensures consistent, controlled crushing performance.

In an exemplary embodiment, the crushing chamber 227 includes a fluid introduction mechanism such as through the syringe port 222 or by loosening the lid 220a, allowing users to add liquid during the crushing process. This feature enables real-time dissolution of pulverized medication, ensuring thorough mixing and enhanced absorption when administered through an enteral feeding tube.

In an exemplary embodiment, the crusher body 220b is provided with a transparent window, allowing users to visually monitor the medication crushing process. This feature ensures that all solid medication 252 is fully pulverized before administration, improving dosage accuracy and reducing the risk of clogging in enteral tubes.

In an exemplary embodiment, a method of using the sealed medication crushing and delivery system 200 is provided. The method comprises introducing a solid medication 252 into the sealed crushing chamber 227 through the first opening 225, adding a liquid solvent through the syringe-connectable inlet 222, and sealing the chamber by securing the lid 220a in place. The motor assembly 240 is then engaged with the crusher assembly 220, and the motor is activated to crush, pulverize, and mix the medication into a liquid suspension. Once the crushing process is completed, the motor assembly 240 is detached, and the liquid suspension is expelled through the discharge outlet 228 directly into an enteral tube by actuation of the enteral syringe 210. This method ensures efficient, contamination-free, and precise medication administration, eliminating manual handling steps and medication loss commonly associated with prior medication preparation methods.

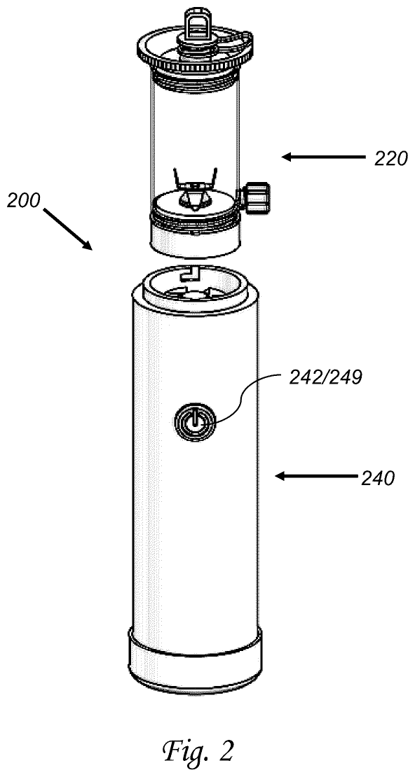

Referring to FIG. 2, there is illustrated one example of a perspective view of the main components of the sealed medication crushing and delivery system 200 in an uncoupled configuration. In an exemplary embodiment, the crusher assembly 220 and the motor assembly 240 are illustrated as separate components, showing their modular and detachable nature. The lid 220a, crusher body 220b, and base 220c of the crusher assembly 220 can be individually removed for cleaning, maintenance, or replacement, ensuring hygienic operation and long-term usability.

The motor assembly 240 is configured to provide rotational power to the crushing mechanism 232 when coupled to the base 220c. In an exemplary embodiment, the motor housing 241 contains an engaging mechanism 244 that aligns with the engaging gear 238 on the crusher assembly 220. When the crusher assembly 220 is securely positioned onto the motor assembly 240, the motor engages the crushing mechanism 232, enabling automated and hands-free medication pulverization. The motor assembly 240 can be battery-powered and may include a safety interlock mechanism to ensure that the crushing process only initiates when all components are properly secured.

The system 200 is designed to be easily assembled and disassembled, allowing for convenient use, cleaning, and maintenance. The motor assembly 240 can be detached from the crusher assembly 220 when not in use, reducing wear on the motor components and allowing for battery conservation. The modular design also enables interchangeability, where different crushing chamber configurations or motorized bases can be used depending on specific user needs.

In an exemplary embodiment, the sealed medication crushing and delivery system 200 provides a safe, efficient, and contamination-free solution for enteral medication preparation. The integration of sealed containment, automated crushing, and direct medication administration eliminates manual effort, multiple transfers, and risks of medication loss or airborne exposure, making it particularly suitable for hospitals, long-term care facilities, and home healthcare settings.

In an exemplary embodiment, a sealed medication crushing and delivery system for enteral administration 200 is provided. The system 200 includes a housing 220b that defines a crushing chamber 227, with an input port 222 configured to receive medication and liquid. A motor-driven crushing mechanism 232 is disposed within the chamber, designed to pulverize solid medications into fine particles. A motor unit 245 is operably coupled to the crushing mechanism 232, supplying rotational power to ensure efficient and consistent medication crushing. An output port 228 is coupled to the crushing chamber 227 and is configured to connect directly to an enteral syringe or enteral tube, allowing for seamless medication administration. The system 200 further includes a safety interlock mechanism that ensures the crushing mechanism operates only when the device is properly engaged, preventing accidental activation and enhancing user safety.

In an exemplary embodiment, the motor unit 245 is configured to operate at a predefined speed and torque, ensuring that solid medications are efficiently pulverized without producing excessive heat or incomplete crushing. The optimized speed and torque settings enable uniform particle size, reducing the risk of enteral tube clogging and medication loss.

In an exemplary embodiment, the system 200 further includes a vented lid 220a with a pressure-equalizing valve to prevent excessive internal pressure buildup during crushing. This feature maintains consistent airflow within the chamber, allowing for controlled pulverization and preventing unintended vacuum effects that could hinder mixing or medication dissolution.

In an exemplary embodiment, the output port 228 includes a one-way valve, ensuring that medication flows only in one direction while preventing leakage and contamination. This valve mechanism enhances system hygiene by blocking backflow, keeping the medication sterile and ready for administration.

In an exemplary embodiment, system 200 includes a detachable lid-locking mechanism that ensures a secure seal between the lid and the crushing chamber 227. This locking mechanism prevents unintentional opening during operation, maintaining a sealed environment that prevents airborne particulate exposure and cross-contamination. Unlike prior systems that rely on friction-based closures, this locking system ensures a reliable, airtight seal.

In an exemplary embodiment, the crushing mechanism 232 is configured as a grinding burr, a set of impact blades, or a milling disc, allowing for different types of medication pulverization techniques. This design ensures effective crushing of a wide range of solid medications 252, from hard tablets to softer capsules, adapting to various pharmaceutical formulations for enteral administration.

In an exemplary embodiment, the safety interlock mechanism includes a magnetic or mechanical sensor, designed to detect proper engagement before operation. This ensures that the crushing mechanism does not activate unless the lid and motor assembly are securely fastened, preventing accidental exposure to moving parts and enhancing operational safety.

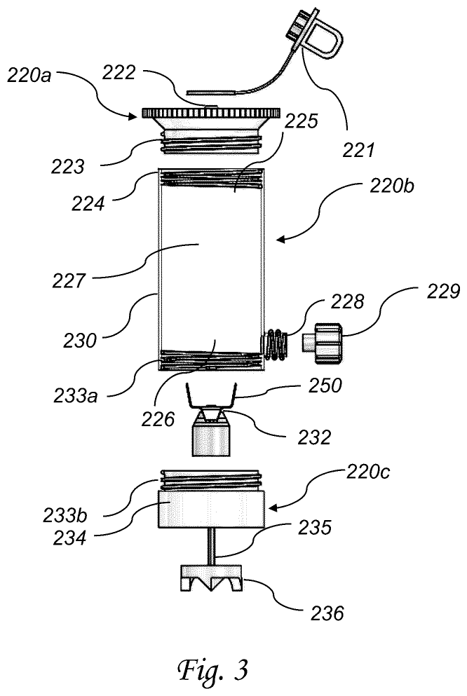

Referring to FIG. 3, there is illustrated one example of a disassembled view of the crusher assembly of the sealed medication crushing and delivery system for enteral administration 200. In an exemplary embodiment, the system 200 comprises a crusher assembly 220 and a motor assembly 240, both of which are shown in an uncoupled state to highlight individual components and their interconnections. The system 200 is designed to enable precise, contamination-free, and automated pulverization of solid medications, which can then be directly administered through an enteral syringe or enteral tube without requiring multiple transfers. The modular design allows for secure coupling and controlled detachment to facilitate ease of use, cleaning, and maintenance, distinguishing it from prior approaches that rely on open crushing mechanisms or manual grinding systems that increase medication loss and exposure risks.

In an exemplary embodiment, the crusher assembly 220 includes a lid 220a, a crusher body 220b, and a base 220c, which together form a sealed crushing chamber designed to contain and process solid medications. The lid 220a features a syringe-connectable inlet 222, allowing users to introduce a liquid solvent or diluent without exposing the medication to external contaminants. A removable port cover 221 is included to seal the syringe inlet 222 when not in use, preventing leakage and environmental exposure.

The crusher body 220b comprises an inner cavity 227 where solid medications are contained and crushed, ensuring even distribution and particle uniformity. A key distinction of the present invention is the incorporation of coupling threads 224 positioned around the first opening 225 of the crusher body 220b. These threads 224 are designed to engage with corresponding threads 223 on the lid 220a, forming a secure, airtight seal that prevents airborne particulates from escaping, reducing the risk of hazardous exposure commonly associated with prior open crushing systems.

The discharge port 228 is located on the lower portion of the crusher body 220b, providing a direct pathway for medication administration once crushing and mixing are complete. Unlike conventional approaches where pulverized medication must be transferred between multiple containers, the present invention enables one-step administration from the crushing chamber to the enteral feeding system, reducing waste and medication loss. A removable discharge port cover 229 is provided to seal the discharge port 228 when it is not in use, further enhancing containment and safety.

The base 220c of the crusher assembly 220 houses a motor-driven crushing mechanism 232. The crushing mechanism 232 includes a set of rotating blades 250 or other pulverizing elements designed to evenly crush medications into fine, easily dissolvable particles. The engaging gear 236 teeth and shaft 235, positioned at the underside of the base 220c, are configured to align with the engaging mechanism 244 of the motor assembly 240, ensuring efficient torque transfer and uniform rotational motion. The second opening 226 of the crusher body 220b features coupling threads 233a, which securely attach to the base 220c, further reinforcing the sealed containment structure of the system 200.

In an exemplary embodiment, a sealed medication crushing and delivery system for enteral administration 200 is provided. The system 200 includes a crusher assembly 220 having a sealed containment chamber 227, which incorporates an entry port 222 for introducing solid medication and a discharge port 228 for delivering a liquid medication mixture. The system is equipped with a motor-driven rotatable blade assembly 232, which is positioned within the containment chamber 227 and configured to crush and mix the medication, ensuring uniform particle size and dissolution before administration.

A motorized base 240 is removably attachable to the containment chamber 227 and is configured to drive the rotatable blade assembly 232, allowing for efficient and controlled pulverization. The system also includes a fluid coupling system that enables the introduction of liquid through the entry port 222 while maintaining a fully enclosed environment, preventing contamination and medication loss. A locking mechanism ensures that the chamber remains securely fastened to the motorized base 240, preventing operation unless properly engaged, thereby enhancing safety and system integrity. The system further includes a manually operable plunger 212 configured to expel the prepared medication mixture through the discharge port 228, facilitating direct enteral administration without requiring manual transfer steps.

In an exemplary embodiment, system 200 further comprises a liquid injection port 222, allowing for the introduction of water or a dissolving solution to aid in medication preparation and suspension. This feature enables precise fluid delivery, ensuring the complete dissolution of crushed medication before administration.

In an exemplary embodiment, the motorized base 240 includes a light-emitting diode (LED) status indicator 249, providing real-time feedback on operational status and battery level. This indicator allows users to monitor system readiness before each use, ensuring optimal performance and reducing the likelihood of unexpected power depletion.

In an exemplary embodiment, the discharge port 228 is equipped with a filtering mechanism, ensuring that the crushed medication mixture maintains uniform consistency. This filtering system prevents large particles or undissolved fragments from being administered, reducing the risk of enteral tube clogging and ensuring accurate dosing.

In an exemplary embodiment, system 200 further includes a manually operable plunger 212, which allows users to expel the medication mixture directly into an enteral tube through the discharge port 228. This plunger mechanism ensures complete medication delivery, preventing residual accumulation within the crushing chamber and minimizing medication waste.

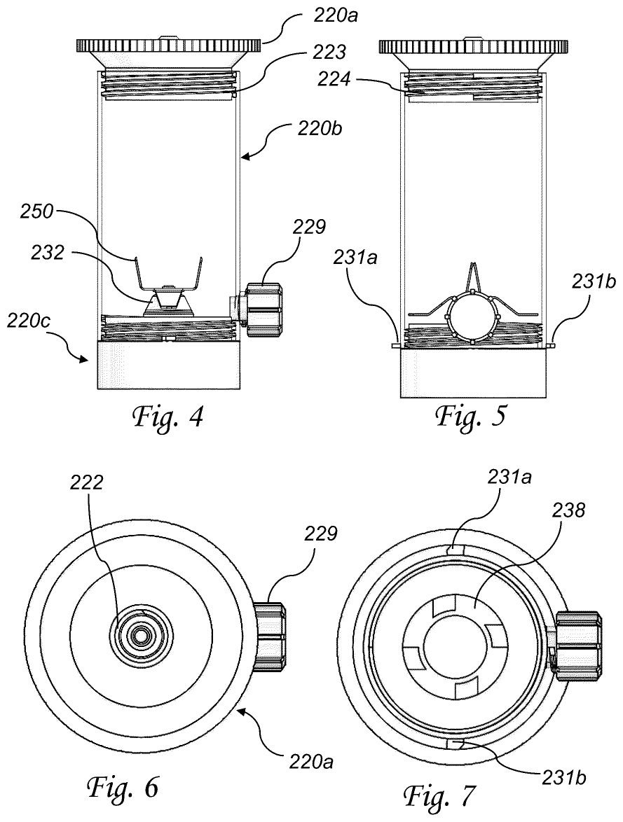

Referring to FIG. 4, there is illustrated one example of a front view of the sealed medication crushing and delivery system 200 in an assembled configuration. In an exemplary embodiment, the syringe-connectable inlet 222 is centrally positioned on the lid 220a, enabling precise liquid introduction for medication suspension or dissolution. The removable port cover 221 is shown secured over the inlet, preventing unintentional leakage when a syringe is not attached.

The discharge port 228 is located at the lower section of the crusher body 220b, providing a direct exit pathway for the medication mixture once the crushing process is completed. The removable discharge port cover 229 is attached to seal the outlet, maintaining a clean environment within the chamber. The transparent section of the crusher body 220b allows users to visually monitor the crushing and mixing process, ensuring that all medication particles are fully pulverized before administration.

The base 220c and motor assembly 240 are shown fully coupled, with the locking nubs 231a and 231b securely engaged. These locking nubs 231a and 231b, located near the second opening 226, interface with corresponding slots 243a and 243b on the motor assembly 240, ensuring a secure, vibration-resistant connection that prevents unintentional detachment during operation.

Referring to FIG. 5, there is illustrated one example of a right-side view of the sealed medication crushing and delivery system 200. The engaging gear 238 is illustrated in at least FIG. 7, positioned at the underside of the base 220c, designed to interact with the engaging mechanism 244 of the motor assembly 240. In an exemplary embodiment, the motor housing 241 encloses a powerful yet compact motor unit capable of delivering consistent rotational force to the crushing mechanism 232. Unlike prior approaches that rely on manual force or external pressure, the motorized design provides uniform, high-efficiency crushing with minimal user effort.

The locking nubs 231a and 231b, visible from the side perspective, highlight the secure engagement features of the system 200. These nubs, when properly aligned with the motor assembly slots 243a and 243b, ensure that the crushing process remains stable and controlled, even under high-torque conditions. Additionally, the motor assembly 240 may include a rechargeable battery compartment, allowing the system to be cordless and portable, distinguishing it from prior electric-powered crushing systems that require continuous external power sources.

In an exemplary embodiment, the sealed medication crushing and delivery system 200 is optimized for single-step medication preparation and administration, reducing cross-contamination risks, medication loss, and operational complexity. The integration of a sealed chamber, automated motorized operation, and direct enteral administration provides a superior solution for clinical, long-term care, and home healthcare applications, ensuring precise dosing, enhanced safety, and ease of use.

Referring to FIG. 6, there is illustrated one example of a top view of the sealed medication crushing and delivery system for enteral administration 200. In an exemplary embodiment, the lid 220a is positioned at the uppermost section of the crusher assembly 220, forming a sealed interface with the crusher body 220b. The syringe-connectable inlet 222 is centrally located on the lid 220a, allowing for fluid introduction directly into the sealed crushing chamber. The removable port cover 221 can be securely fastened over the syringe inlet 222 when not in use, preventing unintended leakage and ensuring a closed, contamination-free system.

The outer perimeter of the lid 220a features gripping ridges or texturing, which can assist users in securely attaching or detaching the lid from the crusher body 220b. Unlike prior approaches that rely on friction-fit closures, the threaded engagement system 223 on the lid 220a and coupling threads 224 on the crusher body 220b create a tight, airtight seal, preventing medication particulates from escaping. The top-down perspective of the system 200 also reveals the alignment markings or indicators on the lid and crusher body, which guide users in properly positioning the lid 220a before engaging the crushing process.

Referring to FIG. 7, there is illustrated one example of a bottom view of the sealed medication crushing and delivery system 200. In an exemplary embodiment, the base 220c is securely coupled to the crusher body 220b, enclosing the crushing mechanism 232. The bottom surface of the base 220c features an engaging gear 238, which is configured to align with the motor assembly's engaging mechanism 244. Unlike prior designs that rely on manual force application, the precise gear alignment system ensures that rotational energy from the motor is efficiently transferred to the crushing mechanism 232, resulting in uniform pulverization of solid medications.

The locking nubs 231a and 231b are visible from the bottom view perspective, further illustrating the secure engagement system that prevents unintentional detachment of the crusher assembly 220 from the motor assembly 240. The base 220c may also incorporate venting channels or heat dissipation elements to manage motor heat buildup, distinguishing the system from prior approaches that lack thermal management considerations.

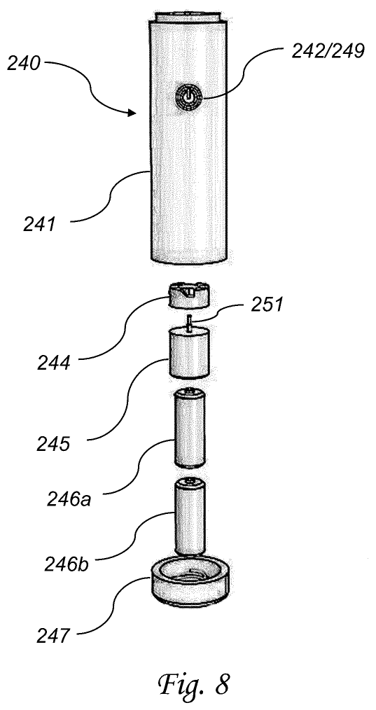

Referring to FIG. 8, there is illustrated one example of a disassembled view of the motor assembly 240 of the sealed medication crushing and delivery system 200. In an exemplary embodiment, the motor assembly 240 comprises a motor housing 241 that encloses a powerful yet compact motor unit 245. The motor unit 245 is designed to deliver consistent torque and speed, ensuring efficient crushing of medications without requiring manual force. The motor shaft 251 extends outward from the motor unit 245 and is connected to an engaging mechanism 244, which interfaces with the engaging gear 238 on the base 220c. A bottom cover 247 can be connected, in a removable manner, to the bottom of the motor housing 241.

The motor housing 241 includes internal support structures that provide stability and vibration control, ensuring smooth and efficient operation. Unlike prior approaches that rely on external stabilization or separate mounting brackets, the present invention incorporates an integrated stabilization system within the motor housing 241 to reduce excessive vibration and noise during operation.

In an exemplary embodiment, the motor assembly 240 includes a rechargeable battery 246a-b, allowing for cordless operation. A charging dock 270 is provided, featuring charging pins 272a and 272b that interface with corresponding contact terminals on the motor housing 241. The cordless design eliminates the need for continuous external power, making the system portable and adaptable for various healthcare environments, including hospitals, long-term care facilities, and home healthcare settings. The charging dock is provided with a power cord 272 to be plugged into an electrical socket to provide power to the motor assembly during charging.

The motor housing 241 further includes a power switch 242, allowing users to activate and deactivate the crushing mechanism 232 with minimal effort. Additionally, the system 200 may incorporate an LED status indicator 249, which provides real-time feedback on battery levels and operational status. Unlike prior approaches that lack user feedback mechanisms, this feature allows clinicians and caregivers to monitor the functionality of the system and ensure optimal performance before each use.

The locking slots 243a and 243b are visible in the disassembled view, further illustrating the secure attachment system between the motor assembly 240 and the crusher assembly 220. These slots 243a and 243b align with the locking nubs 231a and 231b on the crusher body 220b, ensuring that the system remains engaged during operation. Unlike prior approaches that rely on friction-based connections or external clamps, the locking slot mechanism provides reliable, tool-free assembly, reducing set-up time and improving overall usability.

In an exemplary embodiment, the motor assembly 240 is designed to be lightweight yet durable, with a sealed enclosure that protects internal electronic components from dust and liquid exposure. This feature distinguishes the present invention from prior motorized crushing systems, which often lack environmental protection measures, making them susceptible to premature failure in medical and home-use settings.

By integrating a compact motor unit, secure engagement features, and a rechargeable power source, the motor assembly 240 enables efficient, hands-free medication crushing, making the sealed medication crushing and delivery system 200 a superior solution for modern enteral medication administration needs.

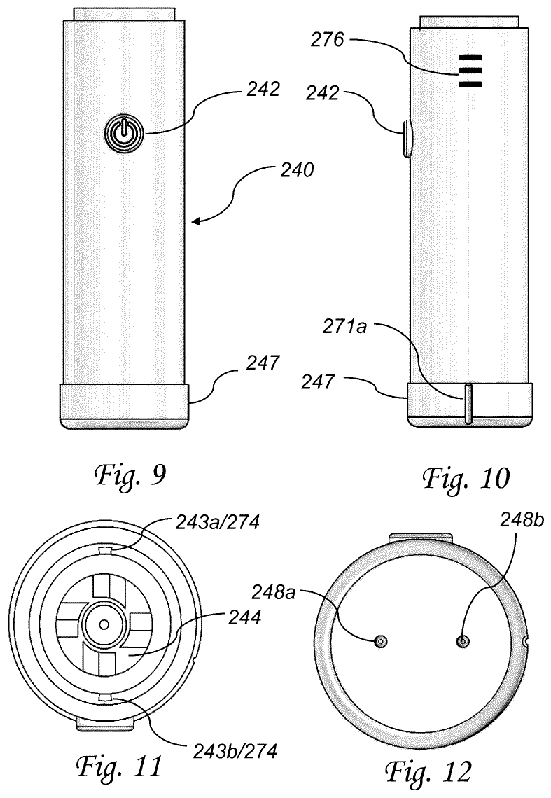

Referring to FIG. 9, there is illustrated one example of a front view of the motor assembly 240 of the sealed medication crushing and delivery system 200. In an exemplary embodiment, the motor housing 241 encloses motor unit 245 and is configured to provide structural support and protection for the internal components. The motor housing 241 is designed with an ergonomic contour to facilitate easy handling and secure attachment to the crusher assembly 220. The power switch 242 is positioned on the front surface, allowing users to activate and deactivate the crushing operation with minimal effort.

The alignment channel 271a is located at the lower section of the motor assembly 240 and is configured to interface with the alignment nub 271b on the charging base 270. The precise alignment of these components ensures corresponding proper alignment of charging terminals 248a, 248b of the motor housing 240 to the charging pins 272a, 272b of the charging base 270 for proper polarity eliminating guesswork on which way the motor housing 240 should be docked.

Additionally, as illustrated in at least FIG. 11, the top view of the motor assembly 240 shows the locking slots 243a and 243b, which are configured to receive the locking nubs 231a and 231b on the crusher body 220b. These features provide a secure interlocking mechanism that prevents accidental detachment during operation, ensuring that the system remains properly engaged throughout the crushing process. In an exemplary embodiment, the locking slots 243a and 243b also contain one or more pressure-sensitive actuators 274 ensuring that the motor is activated only if nubs 231a and 231b are properly engaged to the locking slots 243a, 243b promoting safety during operation.

Referring to FIG. 10, there is illustrated one example of a left-side view of the motor assembly 240. The motor housing 241 is shown in a side perspective, displaying the contoured outer shell designed to protect internal electronics while maintaining a streamlined form factor for user-friendly handling. In an exemplary embodiment, the left-side view highlights ventilation openings 276 or cooling channels, which facilitate heat dissipation during extended use. Unlike prior approaches that lack active thermal management, the present invention ensures that motor overheating is minimized, improving system longevity and consistent performance.

The rechargeable battery 246a-b compartment is positioned within the motor housing 241 and is designed to be easily accessible for battery replacement or recharging. The charging contact terminals 248a-b are integrated at the bottom cover 247 of the motor housing 240, allowing seamless connection to a charging dock 270 when the system is not in use. Unlike conventional plug-in power sources, the contact-based charging design eliminates the need for cumbersome cables, allowing for a clutter-free and efficient power solution.

The left-side view also highlights the motor's torque distribution system, which is engineered to provide consistent crushing force while preventing excessive vibration or instability. Unlike prior systems that rely on direct motor-to-blade connections, the present invention employs an optimized gear-driven torque transfer mechanism, ensuring even force distribution and enhanced durability.

Referring to FIG. 11, there is illustrated one example of a top view of the motor assembly 240. The power switch 242 is positioned to allow a user to easily activate or deactivate of the system. The top-down perspective also reveals the motor assembly's attachment features, including engaging mechanism 244 and recessed locking slots 243a, 243b, which ensure precise positioning when connecting the motor assembly to the crusher assembly 220.

In an exemplary embodiment, the LED status indicator 249 is positioned on the side or as part of the power switch 242 assembly, providing real-time feedback on battery levels and operational status. This feature allows users to monitor the system's readiness before each use, preventing unexpected power depletion and ensuring consistent system availability. Unlike prior approaches that lack visual feedback mechanisms, the present invention incorporates an intuitive LED display, improving user confidence and operational efficiency.

The top view also showcases the balanced weight distribution of the motor housing 241, which ensures that the system remains stable when placed on a flat surface. The integrated design minimizes bulkiness, distinguishing it from larger, less portable motorized crushing systems. By utilizing a compact, rechargeable, and efficiently designed motor assembly, the present invention enhances usability, portability, and reliability in diverse healthcare environments.

Referring to FIG. 12, there is illustrated one example of a bottom view of the motor assembly 240 of the sealed medication crushing and delivery system 200. In an exemplary embodiment, the motor housing 241 encloses and protects the internal motor unit 245, while providing a stable and secure interface for coupling with the crusher assembly 220. The charging contact terminals 248a-b disposed at the bottom of the motor assembly connect to the charging pins 272a-b of the charging base when not in operation to help ensure enough power is stored in batteries for next use. The engaging mechanism 244 is centrally located on the top surface of the motor assembly 240, designed to interface precisely with the engaging gear 238 of the base 220c of the crusher assembly 220. This precision coupling ensures efficient torque transfer, minimizing energy loss and mechanical wear during operation.

The locking slots 243a and 243b are positioned on opposite sides of the upper portion of the motor housing 241, configured to receive locking nubs 231a and 231b from the crusher body 220b. These locking slots provide a secure interlock mechanism, ensuring that the crusher assembly 220 remains firmly engaged with the motor assembly 240 during operation. Unlike prior approaches that rely on friction-based couplings or external clamps, the present invention utilizes a precision-matched engagement system to enhance stability, reduce vibration, and prevent accidental detachment.

The side surface of the motor housing 241 may also include venting channels 276 or cooling aperatures, allowing for air circulation to dissipate heat generated by the motor unit 245. Unlike prior designs that lack active thermal management, the vented motor assembly enhances operational longevity and reliability by preventing overheating during prolonged use.

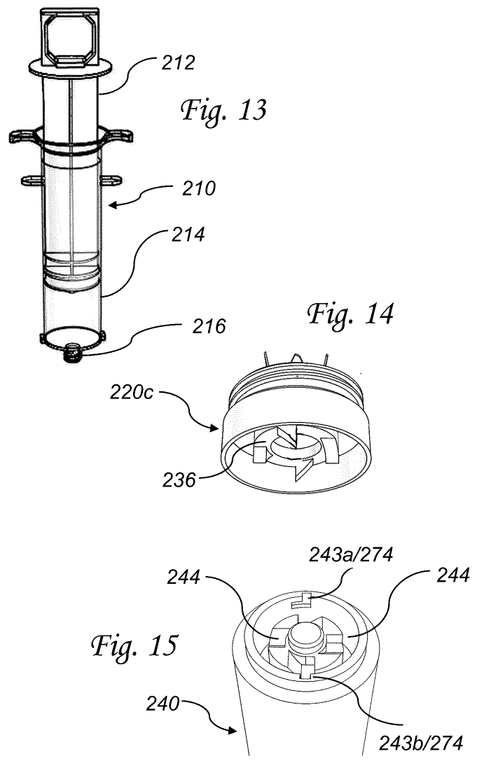

Referring to FIG. 13, there is illustrated one example of a perspective view of an enteral syringe 210, which is designed for precise fluid delivery in enteral feeding applications. In an exemplary embodiment, the enteral syringe 210 includes a barrel 214, a plunger 212, and a female ENFit-compatible outlet 216. The barrel 214 is transparent, allowing users to visually confirm liquid solvent volume and before administration. The plunger 212 is configured to provide controlled fluid displacement, ensuring accurate dosing when expelling liquid medication from the crusher assembly directly into an enteral feeding tube.

The female ENFit-compatible outlet 216 is specifically designed for a secure and leak-proof connection with Ethe NFit-compatible inlet of the crushing assembly. Unlike standard Luer syringes, which can pose misconnection risks with intravenous components, the ENFit standard ensures that the syringe 210 is exclusively compatible with enteral feeding systems, enhancing patient safety and reducing cross-connection hazards. The enteral syringe 210 can be used to introduce liquid into the sealed medication crushing system 200 through the syringe-connectable inlet 222 on the lid 220a, enabling precise dilution of crushed medication before administration.

Referring to FIG. 14, there is illustrated one example of a bottom perspective view of the base of the sealed medication crushing and delivery system assembly 220c. In an exemplary embodiment, the base 220c houses the crushing mechanism 232 and provides a secure interface for attachment to the motor assembly 240. The engaging gear 236 is centrally located on the bottom surface of the base 220c, configured to align with the engaging mechanism 244 of the motor assembly 240. The gear-driven connection ensures precise rotational force transfer, allowing for uniform and efficient pulverization of solid medications.

As better illustrated in at least FIG. 5, the locking nubs 231a and 231b extend outward from the base perimeter, aligning with the locking slots 243a and 243b on the motor assembly 240. This secure interlocking design prevents unintended detachment, ensuring that the system remains stable and properly engaged throughout the crushing process. Unlike prior designs that rely on manual pressure or snap-fit connections, the present invention utilizes a guided locking mechanism that provides repeatable, secure engagement with minimal user effort.

Additionally, the bottom surface of the base 220c may include support ridges or anti-slip elements, which enhance stability when placing the crusher assembly on a flat surface. The support ridges prevent unnecessary movement, ensuring consistent medication processing without external disturbances. Unlike prior approaches that feature unstable, manually operated crushing devices, the present invention incorporates integrated stabilization features to enhance usability, safety, and efficiency.

Referring to FIG. 15, there is illustrated one example of a close-up top-perspective view of the upper portion of the crusher device motor assembly 240. In an exemplary embodiment, the motor housing 241 encloses the internal motor unit 245 and is designed for structural durability and ergonomic handling. The power switch 242 can be positioned on the side surface of the motor housing 241, allowing for convenient activation and deactivation of the crushing process. The L-shaped locking slots 243a-b can have pressure-sensitive pins that allow activation of the motor only when the crusher assembly 220b is secured and properly engaged.

The LED status indicator 249 is also located on the top surface or integrated as part of the power switch assembly 242, providing visual feedback regarding battery level, operational readiness, and system status. This feature allows users to monitor the device's charge level before initiating a crushing cycle, ensuring continuous and reliable operation. Unlike prior systems that lack user feedback mechanisms, the integration of an LED indicator enhances usability and reduces the likelihood of unexpected power loss during medication preparation.

The top view perspective also reveals structural reinforcements within the motor housing 241, which are designed to reduce mechanical vibration and stabilize the crushing process. Unlike prior systems that require external stabilization, the present invention incorporates internal damping features to ensure consistent, uniform crushing performance without excessive noise or vibration.

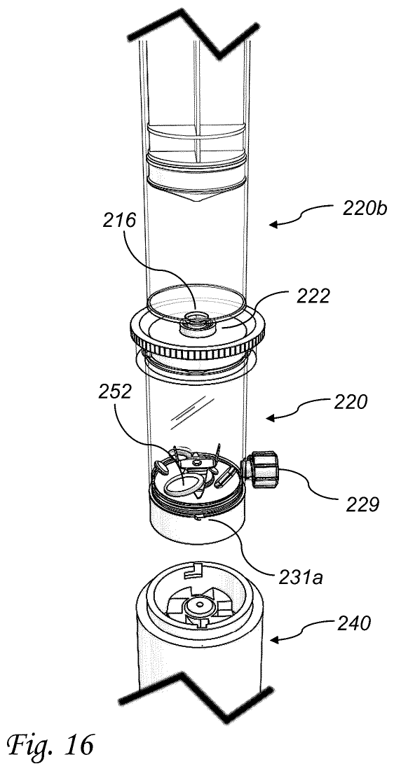

Referring to FIG. 16, there is illustrated one example of a close-up view of the sealed medication crushing and delivery system assembly, showing the system in use with pills loaded into the crushing chamber and connected to an enteral syringe, while being uncoupled from the motor assembly 240. In an exemplary embodiment, the crusher assembly 220 is depicted with its lid 220a securely attached to the crusher body 220b, forming a sealed containment chamber to prevent airborne particulate exposure during the crushing process. The syringe-connectable inlet 222 is engaged with an enteral syringe 210, enabling precise liquid introduction into the chamber before or after crushing.

Inside the crusher body 220b, uncrushed solid medication is visible, demonstrating the pre-crushing state of the medication. The sealed design of the chamber prevents medication dust from escaping, distinguishing it from prior open-container crushing approaches. The base 220c of the crusher assembly 220 remains uncoupled from the motor assembly 240 in this view, highlighting the modular design that allows for separate handling of the crushing chamber.

The uncoupled state of the motor assembly 240 demonstrates the ease of detachment and reattachment, allowing users to transfer the medication preparation system independently from the motorized base. This feature is particularly beneficial in clinical environments, where multiple crushing chambers may be used interchangeably with a single motor assembly, improving workflow efficiency and reducing cleaning requirements between uses.

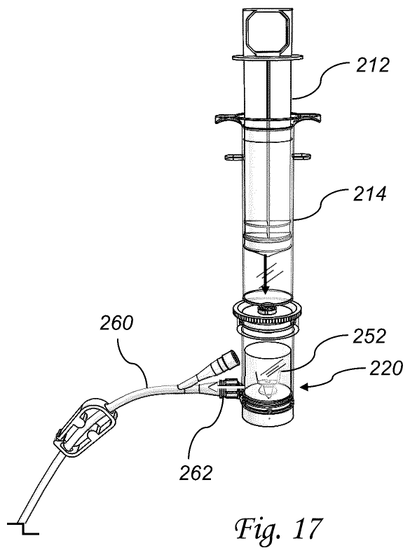

Referring to FIG. 17, there is illustrated one example of a perspective view of the sealed medication crushing and delivery system assembly, showing the medication in a fully processed state, where solid pills have been pulverized and mixed into a liquid suspension. In this exemplary embodiment, the crushed and dissolved medication mixture is housed within the sealed containment chamber, ensuring homogeneous mixing and even particle distribution before administration.

The enteral syringe 210 remains connected to the syringe-connectable inlet 222, demonstrating the direct fluid transfer capability of the system. Additionally, the discharge port 228 is connected to an enteral tube, allowing for immediate and contamination-free administration to the patient. Unlike prior methods that require multiple transfers between grinding surfaces, mixing containers, and administration syringes, the present invention enables one-step processing from crushing to delivery, minimizing medication loss and exposure risk.

The secure attachment of the enteral syringe and enteral tube in this view also highlights the sealed and leak-proof design of the system, preventing liquid medication spills or contamination during transfer. The integration of an optimized crushing and mixing mechanism ensures that no large particles remain, preventing clogging of the enteral tube-a common issue with prior medication preparation approaches.

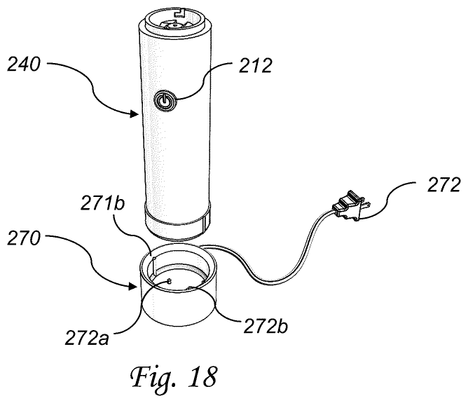

Referring to FIG. 18, there is illustrated one example of a perspective view of the motor unit of the present disclosure uncoupled from a charging dock 270. In an exemplary embodiment, the motor assembly 240 is configured to operate using a rechargeable battery system, enabling cordless operation to enhance portability and usability in various environments. The motor housing 241 encases the internal motor unit 245 and battery 246a-b, ensuring protection from external contaminants and mechanical damage.

The bottom cover 247 of the motor housing 241 features charging contact terminals that align with corresponding charging pins 272a and 272b on the charging dock 270. Unlike prior systems that rely on cumbersome external power cords, the present invention incorporates a direct-contact charging mechanism, allowing users to dock the motor assembly onto the charging base for seamless recharging. This feature minimizes setup time and eliminates the need for frequent battery replacements, improving operational efficiency in clinical and home healthcare settings.

In an exemplary embodiment, the charging dock 270 is compact and designed to accommodate the motor assembly 240 in an upright or stable resting position. The dock may also feature an LED indicator to provide users with real-time feedback on charging status, ensuring that the motor is fully charged and ready for use. Unlike conventional electric medication crushers that require continuous power connections, the cordless charging design enhances mobility, allowing for greater flexibility in medication preparation.

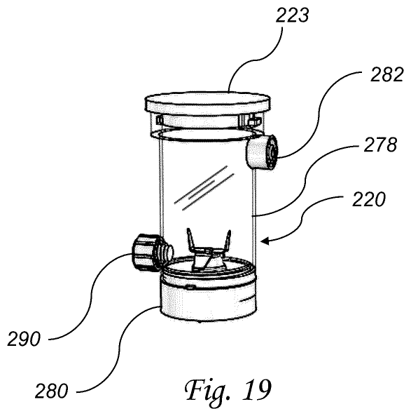

Referring to FIG. 19, there is illustrated one example of a front-perspective view of another embodiment of the sealed medication crushing and delivery system assembly. In an exemplary embodiment, this configuration features modifications to the crusher assembly and its interface with the motor assembly, while maintaining the core functionality of sealed medication crushing and direct enteral administration.

The crusher assembly 220 includes a lid 223, a crusher body 278, and a base 280, similar to the previous embodiment but with design refinements for ergonomic handling and enhanced sealing performance. The syringe-connectable inlet 282 and discharge port 290 remain integral to the design, ensuring that medication can be precisely diluted and directly transferred to an enteral tube without contamination.

The motor assembly in this embodiment incorporates an updated attachment mechanism, featuring an alternative locking system that enhances user convenience and operational stability. The engaging mechanism has been modified to provide improved alignment between the motor assembly and the crusher base 280, ensuring seamless coupling and secure engagement. The locking slots have been repositioned for optimized torque distribution, reducing mechanical strain and improving long-term durability.

This alternative embodiment also introduces enhanced vibration-dampening elements within the motor housing, designed to reduce operational noise and minimize excess movement during the crushing process. Unlike prior approaches that rely on external stabilization measures, this embodiment integrates internal vibration control, ensuring consistent medication pulverization with minimal user effort.

Additionally, this embodiment of the system may include an upgraded LED status display, providing users with expanded feedback options, such as battery level monitoring, crushing cycle completion alerts, and error detection indicators. The inclusion of intelligent feedback mechanisms enhances user confidence and system reliability, distinguishing it from manual or semi-automated crushing systems that lack built-in monitoring features.

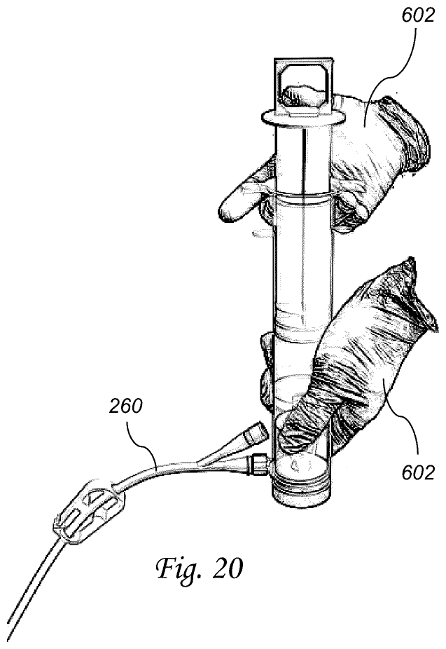

Referring to FIG. 20, there is illustrated an example of technician 602 using the sealed medication crushing and delivery system. This embodiment demonstrates the operational use of the system, highlighting its ergonomic design and ease of handling in a clinical or healthcare setting.

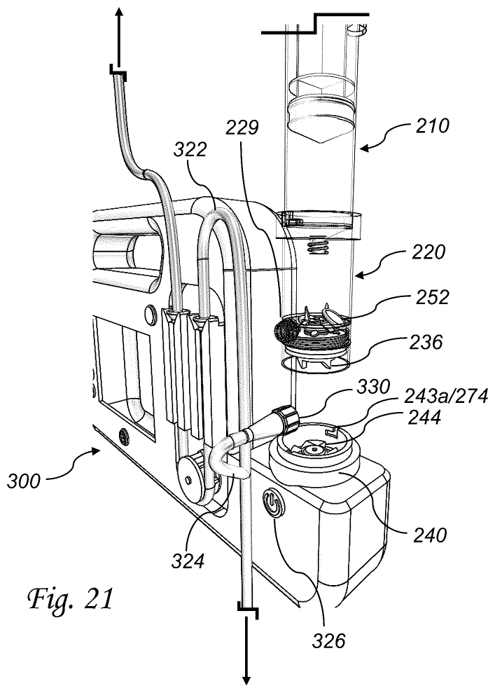

Referring to FIG. 21, there is illustrated one example of how the sealed medication crushing and delivery system is integrated into an enteral feeding pump 300. In this configuration, the crushing housing assembly 220 is shown disengaged from the engaging mechanism 244 of the motor assembly housed within the enteral feeding pump 300. The motor assembly draws power from and is controlled by the enteral feeding pump system.

In an exemplary embodiment, the crushing vessel 220 is designed to selectively receive solid medications such as tablets 252 for pulverization. The crushing vessel includes an inlet 222 configured for fluid introduction, allowing liquid to be added to aid in dissolution. The outlet 228 of the crushing vessel 220 is ENFit-compatible, ensuring secure attachment to an enteral connector or enteral feeding tubes.

The enteral pump tubing system 322 is configured to interface with the crushing vessel outlet 228. The tubing system 322 incorporates a Y-connector 324 that features an ENFit male interface 330 for selective engagement with the crushing vessel outlet 228. The enteral feeding pump system 300 can be used to deliver liquid medication directly through the enteral tubing system, ensuring precise and contamination-free administration.

An optional switch 326 is integrated into the enteral feeding pump 300 to allow for selective activation of the crushing mechanism. Additionally, a clamp 336 is included to occlude a portion of the tubing system, ensuring that fluid flow is controlled during the medication preparation and delivery process.

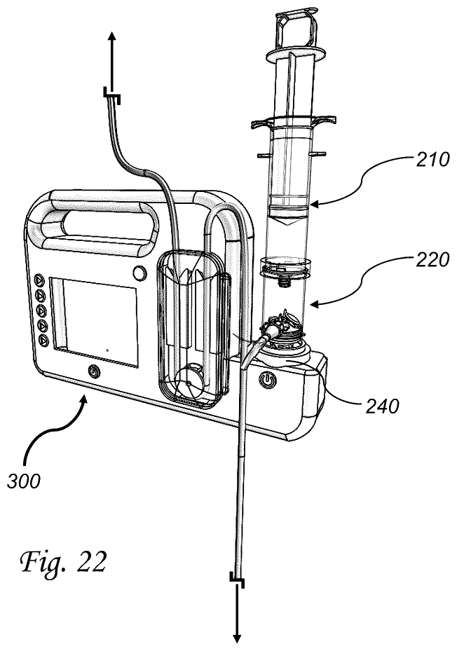

Referring to FIG. 22, there is illustrated one example of the sealed medication crushing and delivery system integrated into an enteral feeding pump 300 with the crushing housing assembly 220 and the motor housing engaged. In this configuration, the engaging mechanism 244 of the motor assembly 240 is fully interfaced with the crushing vessel 220, enabling powered medication pulverization.

In an exemplary embodiment, the tablets 252 placed within the crushing vessel 220 are now subject to the engaging mechanism's rotational force, ensuring efficient grinding and dissolution. The clamp 336 remains closed, diverting fluid flow through the crushing vessel 220 to facilitate dissolution of the pulverized medication.

The enteral pump system 300 supplies liquid via the proximal Y-branch 323 into the crushing vessel inlet 222, ensuring that medication is evenly suspended before administration. The motor assembly 240 may continue to operate to further mix the liquid with the pulverized medication, ensuring complete dissolution before transfer.

The safety interlock mechanism ensures that the crushing vessel 220 remains securely engaged with the motor assembly 240 before activation, preventing accidental detachment during operation.

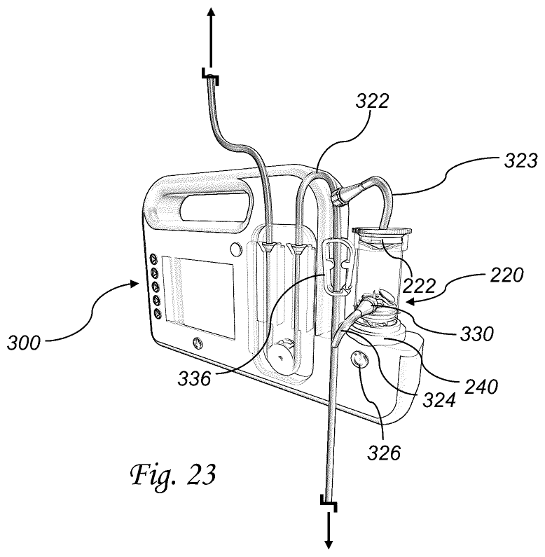

Referring to FIG. 23, there is illustrated one example of how the sealed medication crushing and delivery system 220 is fully integrated with an enteral feeding pump 300 and connected to the enteral feeding tubing system 322 for direct administration of the medication suspension.

In an exemplary embodiment, the engaging mechanism 244 has completed the pulverization of tablets 252 within the crushing vessel 220. The clamp 336 is now released, allowing fluid to flow from the enteral pump system 300 into the crushing vessel 220, dissolving the comminuted medication before transfer through the distal Y-branch 324.

In an exemplary embodiment, the engaging mechanism 244 has completed the pulverization of tablets 252 within the crushing vessel 220. The clamp 336 remains closed, diverting fluid flow to the crushing vessel 220 to facilitate dissolution of the pulverized medication and allowing fluid to flow from the enteral pump system 300 into the crushing vessel 220, dissolving the comminuted medication before transfer through the distal Y-branch 324.

Once the medication is fully dissolved, the enteral feeding pump system 300 is operated to force the prepared liquid medication through the crushing vessel outlet 228 and into the distal Y-branch 324. This mechanism allows for precise, contamination-free, and direct medication administration to the patient's enteral feeding tube 260.

Once administration of the pulverized medication mixture is finished, the proximal y-tubing 323 is disconnected from the inlet 222 of crushing assembly 220 and the distal y-tubing 330 is disconnected from the outlet 228 of the crushing assembly 220. The proximal y-tubing 323 and the distal y-tubing are connected keeping a closed system. The clamp is then opened to allow continuous delivery of formula into the patient.

If an enteral syringe 210 is connected to the crushing vessel inlet 222, it may be used to augment the expelling force, ensuring complete medication transfer. Alternatively, the enteral feeding pump system 300 may solely provide the necessary pressure, eliminating the need for manual syringe actuation.

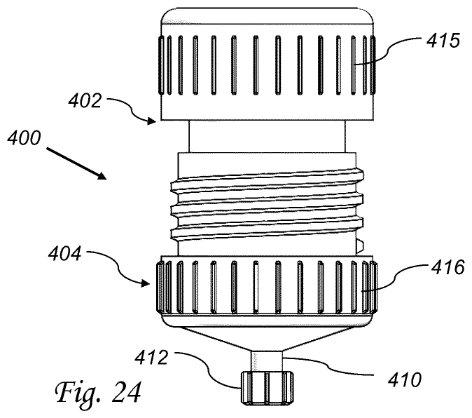

Referring to FIG. 24, there is illustrated one example of a front view of an embodiment of the sealed medication crushing and delivery system 400, with the first main body 402 in a retracted position. In this embodiment, the system is designed to provide a controlled and sealed crushing process, ensuring effective medication pulverization while preventing airborne contamination.

The first main body 402 is positioned above the second main body 404, forming an internal crushing chamber 406. The first main body 402 has internal threads 418. The first main body 402 is designed to move axially relative to the second main body, allowing it to be lowered into a crushing position when force is applied. In the retracted position, chamber 406 remains open, allowing a tablet or solid medication 252 to be placed onto the tablet support surface 460.

The entry port 406 is located at the top of the first main body 402, allowing fluid to be introduced into the chamber 430 when necessary. A removable cap 407 covers the entry port 406 when not in use, preventing external contaminants from entering the system. The first main body 402 also features grip-enhancing ridges 415, providing improved handling for the user when engaging the crushing motion.

The second main body 404 has external threads 420 that engage with the internal threads 418 on the first main body 402. The second main body 404 houses the tablet support surface 460 and the discharge port 410. The tablet support surface 460 ensures that the tablet remains stable during the crushing process, preventing unintended movement that could result in incomplete pulverization. The discharge port 410 is positioned at the lower portion of the second main body, designed to allow direct expulsion of the medication mixture once crushing and dissolution are complete.

A sealing ring 424 is disposed between the first and second main bodies, ensuring that the chamber remains airtight when the first main body is lowered into the crushing position. The sealing ring prevents leakage, ensuring that airborne particles are contained within the crushing system.

In this retracted position, the system is ready to receive a solid medication 252 for processing. Once the tablet is positioned on the support surface, the first main body is moved downward, initiating the crushing sequence as described in subsequent figures.

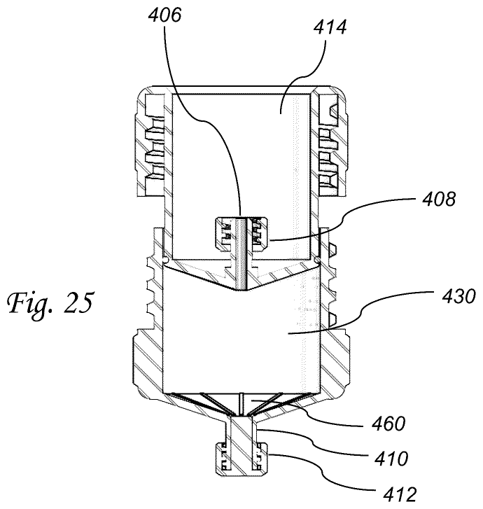

Referring to FIG. 25, there is illustrated one example of a cross-sectional view of an embodiment of the sealed medication crushing and delivery system 400. In this embodiment, the system includes a first main body 402 and a second main body 404, which together define a sealed crushing chamber 430. The first main body 402 is configured to move axially relative to the second main body, enabling crushing force to be applied to solid medications contained within chamber 430.

The entry port 406 is positioned at the upper surface of the first main body 402 and is configured to allow for fluid introduction into the crushing chamber 406. The entry port 406 may include a removable cap 407 to maintain a sealed environment when not in use, preventing contamination or unintended fluid exposure. The internal walls of the first main body 402 are shaped with guide ridges, which help maintain axial alignment during the crushing motion.

At the lower portion of the second main body 404, a discharge port 410 is provided, facilitating direct administration of the crushed and dissolved medication. The discharge port 410 is designed to connect to a feeding tube, ensuring seamless delivery of the prepared medication suspension. The sealing ring 424 is positioned between the first and second main bodies, ensuring a leak-proof connection when the system is engaged.

Inside the crushing chamber 406, the tablet support surface 460 is structured to hold solid medications in place, preventing tablet displacement during the crushing process. The first main body 402 is equipped with internal crushing ridges 422a that interact with the tablet support surface 460 when downward force is applied, ensuring effective grinding and particle reduction.

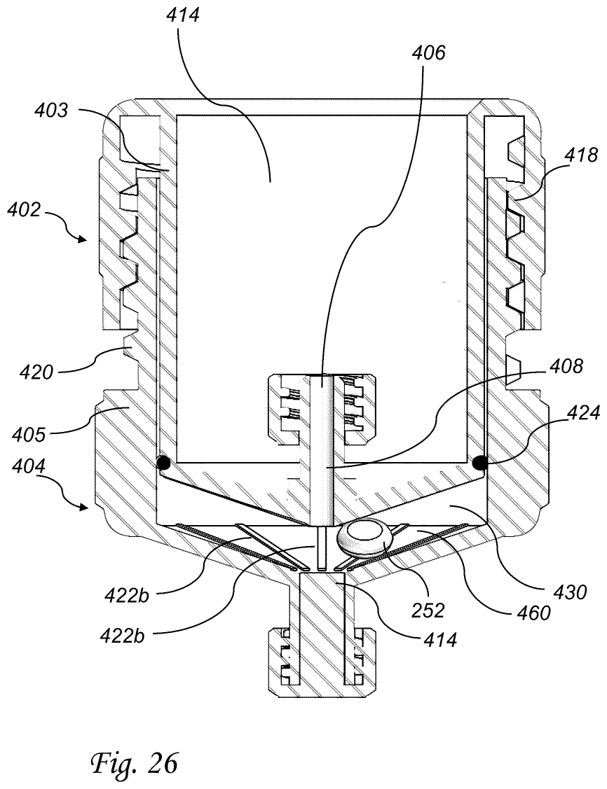

Referring to FIG. 26, there is illustrated one example of the sealed medication crushing and delivery system 400 with the first main body 402 in a depressed position containing a tablet 252. In this state, the first main body 402 has been moved downward, exerting mechanical pressure on the solid medication 252 within the crushing chamber 430.

The tablet support surface 460, positioned within the second main body 404, ensures that the tablet remains stable during the crushing motion. The internal crushing ridges 422a engage with the tablet, facilitating breakdown into smaller particles. This crushing motion may be performed manually or assisted by a mechanical force, depending on the embodiment.

As the first main body 402 is depressed, the sealing ring 424 maintains a closed system, preventing airborne medication particulates from escaping. Once the tablet has been crushed, fluid can be introduced through the entry port 406 to aid in medication dissolution. The resulting liquid suspension is then expelled through the discharge port 410 for direct enteral administration.

This alternative embodiment provides an effective and controlled crushing mechanism, ensuring uniform particle size and seamless fluid integration. Unlike prior medication crushers that rely on external mixing steps, this system allows for crushing, dissolution, and delivery in a single sealed device, improving efficiency and reducing contamination risks.

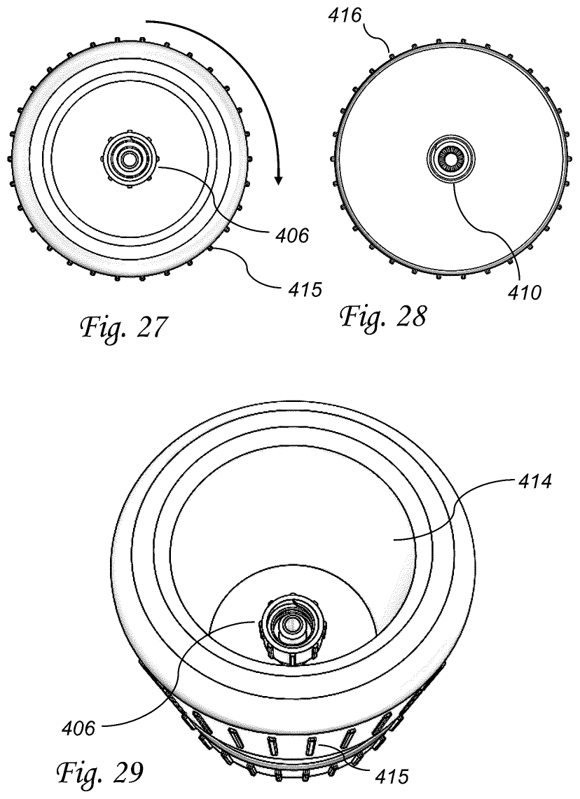

Referring to FIG. 27, there is illustrated one example of a top view of an embodiment of the sealed medication crushing and delivery system 400. In this embodiment, the first main body 402 is visible from the top perspective, showing its circular or slightly contoured shape for ergonomic handling.

The entry port 406 is centrally located on the first main body 402, allowing precise liquid introduction into the crushing chamber 430. The entry port 406 may include a removable cap 407, which provides a secure seal when not in use, preventing contaminants from entering the chamber. The cap 407 may be tethered to the first main body, ensuring that it remains attached to the system during use.

Surrounding the outer surface of the first main body 402 are grip-enhancing ridges 415, which facilitate secure handling and controlled force application during the crushing process. These ridges allow users to firmly grasp and rotate or press the system as needed, ensuring effective medication pulverization.

The sealing ring interface 423 is positioned near the bottom edge of the first main body 402, ensuring that when the system is in a compressed state, the chamber remains airtight and prevents leakage. The threaded engagement or compression fit between the first main body 402 and second main body 404 may also be partially visible, depending on the specific design of the embodiment.

Referring to FIG. 28, there is illustrated one example of a bottom view of the sealed medication crushing and delivery system 400. The second main body 404 is visible in this perspective, showing the foundation of the crushing system, which provides stability during operation.

The discharge port 410 is centrally located on the bottom surface of the second main body 404, allowing for direct expulsion of the crushed and dissolved medication. The discharge port 410 is designed to connect to an enteral syringe or feeding tube, ensuring seamless medication administration without requiring intermediate transfers.

A discharge port cover 412 may be included, providing a seal when the port is not in use, preventing leakage and contamination. The discharge port cover 412 may be removable or tethered to ensure it remains readily accessible when needed.

Additionally, stability features such as a non-slip base or support ridges 426 may be incorporated into the bottom surface of the second main body 404. These elements ensure that the system remains stable on a flat surface during manual or mechanical crushing operations, preventing unintended movement that could affect medication consistency.

Referring to FIG. 29, there is illustrated one example of a top perspective view of an embodiment of the sealed medication crushing and delivery system 400. This view provides a three-dimensional perspective of how the first main body 402 and second main body 404 interact.

The entry port 406 is clearly visible, showing its central positioning on the top surface of the first main body 402. Cap 412 is in place, ensuring that the system remains sealed when not in use. The grip-enhancing ridges 415 extend along the periphery of the first main body, allowing for improved handling and control when applying force to crush medications.

From this angled perspective, the internal structure of the sealing ring interface 423 is partially visible, highlighting how the first main body 402 engages with the second main body 404. The crushing chamber 430, though not fully exposed in this view, is positioned between the two main bodies and is engineered to contain and direct force efficiently for medication pulverization.

The discharge port 410 is partially visible at the bottom section of the second main body 404, showing how it aligns for direct medication flow into an enteral syringe or feeding tube. This perspective also showcases the tapered or contoured edges of the system, designed to improve ergonomics and user control during operation.

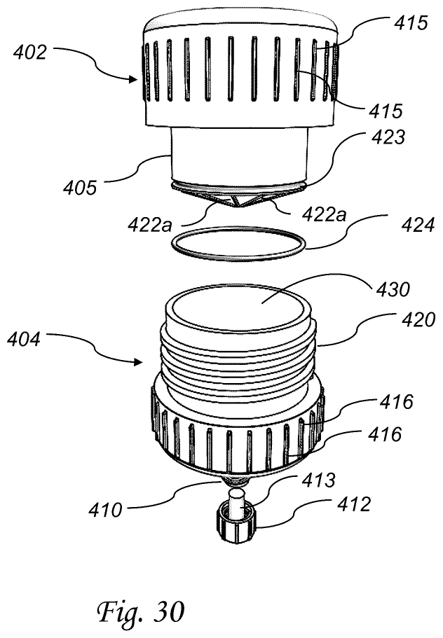

Referring to FIG. 30, there is illustrated one example of a disassembled view of an embodiment of the sealed medication crushing and delivery system 400. This view provides a breakdown of the individual components, showcasing how the system assembles for use.

The system comprises a first main body 402 and a second main body 404, which together form a sealed crushing chamber 430. The first main body 402 is designed to be removably attached to the second main body 404 through a threaded or compression-fit engagement. The crushing chamber 430 is configured to contain solid medication during pulverization. The distal ends of the crushing projection 405 are formed with a geometry of blunt bars 422a. Correspondingly, the bases of the grinding groove 430 is formed with a geometry of bar-shaped recesses or uneven surfaces 422b.

At the top surface of the first main body 402, an entry port 406 is provided for fluid introduction. The removable cap 407 is designed to securely seal the entry port when not in use, preventing external contamination. The outer surface of the first main body 402 includes grip-enhancing ridges 415, allowing controlled handling and application of force during the crushing process.

The second main body 404 houses the tablet support surface 460, which ensures proper positioning of solid medication for crushing. The second main body 404 feature crushing ridges 422b that interact with the tablet support surface 460, ensuring efficient particle size reduction when force is applied.

At the lower portion of the second main body 404, a discharge port 410 is provided for direct expulsion of the crushed medication. The discharge port 410 is designed for attachment to an enteral connector or enteral feeding tube, facilitating seamless medication administration without the need for intermediate transfers. A removable discharge port cover 412 ensures that the port remains sealed when not in use, preventing leakage and contamination.

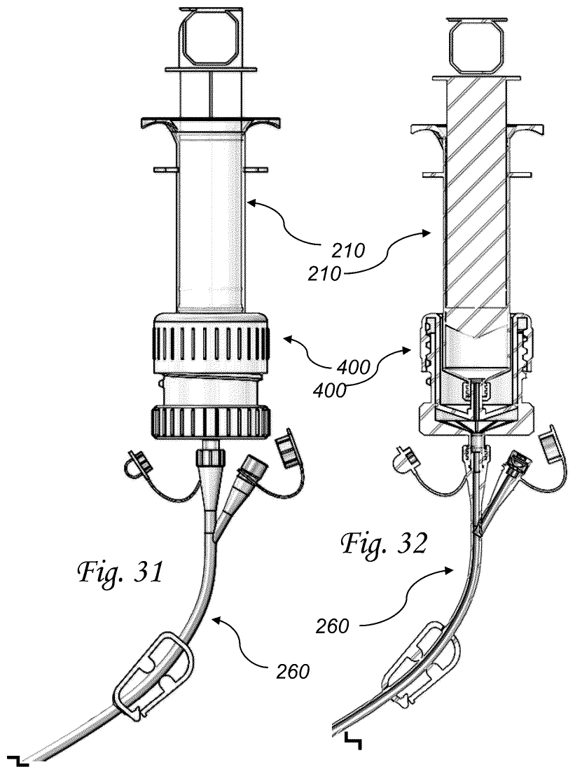

Referring to FIG. 31, there is illustrated one example of a front view of an embodiment of the sealed medication crushing and delivery system 400, shown connected to an enteral syringe 210 and an enteral tube 260. This configuration demonstrates the system's direct integration with enteral administration devices, ensuring efficient and contamination-free medication delivery.

The first main body 402 is engaged with the second main body 404, forming a sealed containment system. The entry port 406 is connected to an enteral string. The grip-enhancing ridges 415 on the first main body 402 are visible, designed to provide improved user control when applying force during the crushing process.

At the lower portion of the second main body, the discharge port 410 is actively connected to an enteral tube 260. The enteral syringe 210 provides fluid for dissolving the crushed medication and providing force enabling direct fluid transfer from the crushing chamber to the patient's feeding line.

This closed-system design eliminates intermediate handling, reducing medication loss, exposure to contaminants, and dosage inconsistencies. The sealing ring 424 between the first and second main bodies ensures that the system remains airtight and leak-free throughout the crushing and fluid transfer process.

Referring to FIG. 32, there is illustrated one example of a cross-sectional view of an embodiment of the sealed medication crushing and delivery system 400, showing its internal configuration while connected to an enteral syringe 210 and an enteral tube 260.

This cross-sectional perspective reveals the internal crushing chamber 406, which is enclosed by the first main body 402 and second main body 404. The tablet support surface 460 is positioned at the bottom of the chamber, ensuring that solid medications remain stationary during pulverization. The internal crushing ridges 422a-b are visible, providing mechanical friction to break down medication into fine particles.

The entry port 406 at the top of the first main body 402 is sealed and connected to the enteral syringe 210. The sealing ring 424 ensures that no fluid escapes during the crushing and mixing process. Once the medication is crushed and mixed with liquid, it is expelled from the crushing chamber 430 and directly into the enteral tube 260 by depressing the plunger of the enteral syringe.

This integrated design ensures that all crushed medication is effectively delivered, reducing residual waste and ensuring accurate dosing.

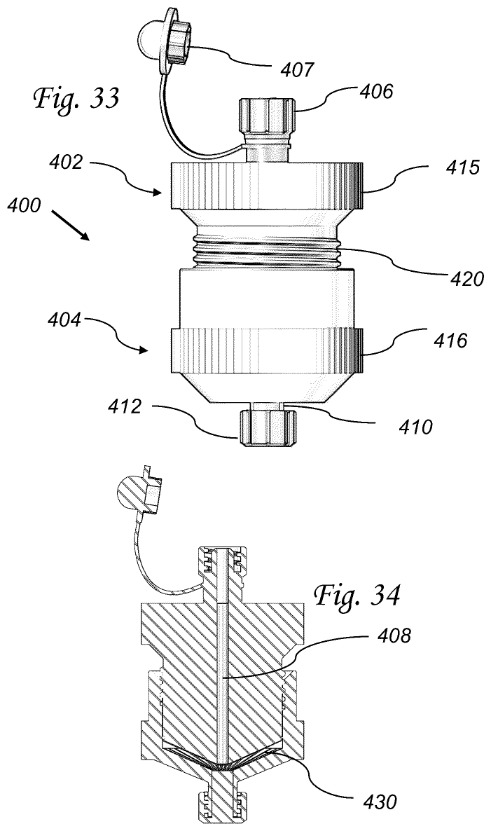

Referring to FIG. 33, there is illustrated one example of an embodiment of the sealed medication crushing and delivery system 400. This embodiment features a refined structure, maintaining the core functionality of sealed medication crushing and direct enteral administration, while introducing design optimizations for improved usability and sealing performance.

The system comprises a first main body 402 and a second main body 404, which together form a sealed containment system for medication crushing. The first main body 402 is configured to move axially relative to the second main body, enabling precise application of crushing force. The outer surface of the first main body 402 is designed with grip-enhancing ridges 415, allowing secure handling during operation.

At the top of the first main body, an entry port 406 is provided for introducing liquid into the crushing chamber 410. A removable cap 407 is secured to the entry port, ensuring that the system remains airtight and contamination-free when not in use. The crushing chamber 430 is designed to contain solid medications, ensuring they remain properly positioned during the crushing process.

The second main body 404 houses the tablet support surface 460, which prevents tablet displacement during crushing, ensuring consistent pressure distribution. The first main body 402 features crushing ridges 422a, which interact with the tablet support surface 460 to efficiently grind and reduce particle size.

The discharge port 410 is positioned at the lower section of the second main body, allowing direct connection to an enteral feeding tube. A removable discharge port cover 412 is provided to seal the port when not in use, preventing fluid leakage and ensuring clean operation.

Referring to FIG. 34, there is illustrated one example of a cross-sectional view of an embodiment of the sealed medication crushing and delivery system 400. This internal view provides a detailed perspective on the mechanical interaction between components, ensuring efficient medication crushing and dissolution.

The crushing chamber 430 is enclosed by the first main body 402 and the second main body 404, creating a sealed containment system. The tablet support surface 460 is positioned at the bottom of the chamber, ensuring that solid medications remain stable during crushing. The internal crushing ridges 422a are structured to optimize particle size reduction, improving dissolution efficiency when liquid is introduced.

Disposed at the bottom of the second main body 402 is a discharge port 410. A discharge port cover 412 may be included. The length of the central shaft 414 of the discharge port 410 is substantially equivalent to the internal depth of discharge port 410, preventing the deposition of crushed or uncrushed medication within discharge port 410.

The entry port 406, located at the top of the first main body, enables fluid introduction to dissolve the crushed medication. The removable cap 407 ensures that the system remains sealed when not in use, preventing contaminants from entering the crushing chamber.

At the bottom of the second main body, the discharge port 410 provides a direct fluid pathway for medication administration. Once the medication is fully crushed and dissolved, it can be expelled directly into an enteral tube, ensuring precise dosing with minimal waste.

A sealing ring 424 is positioned between the first and second main bodies, ensuring that the system remains airtight and leak-proof throughout the operation. This prevents unintentional fluid leakage while maintaining a fully enclosed crushing environment

This embodiment retains the functional principles of previous designs while incorporating ergonomic and structural improvements, optimizing sealing, handling, and medication administration.

While the preferred embodiment of the invention has been described, it will be understood that those skilled in the art, both now and in the future, may make various improvements and enhancements which fall within the scope of the claims which follow. These claims should be construed to maintain the proper protection for the invention first described.

What is claimed is:

1. A sealed medication crushing and delivery system for enteral administration, the sealed medication crushing and delivery system comprising:
a crusher assembly comprising:
a lid with a syringe-connectable inlet and an enteral tube-connectable discharge outlet;
a crusher body forming a sealed crushing chamber for containing medications; and
a base with a crushing mechanism configured to pulverize solid medications;
a motor assembly configured to engage with the crusher assembly and provide rotational power to the crushing mechanism;
the crusher body, lid, and base forming a sealed containment system to prevent the release of airborne particulates during medication crushing; and
the enteral tube-connectable discharge outlet providing a direct medication transfer pathway to administer the pulverized medication through an enteral tube without intermediate transfers.

2. The sealed medication crushing and delivery system of claim 1, wherein the crushing mechanism comprises a set of rotating blades configured to crush, pulverize, and mix solid medication within the sealed chamber.

3. The sealed medication crushing and delivery system of claim 1, wherein the enteral tube-connectable discharge outlet is ENFit-compatible.

4. The sealed medication crushing and delivery system of claim 1, wherein the motor assembly includes a rechargeable battery.

5. The sealed medication crushing and delivery system of claim 1, wherein the motor assembly further comprises a pressure-sensitive activation switch to engage the motor when the crusher assembly is secured in place.

6. The sealed medication crushing and delivery system of claim 1, wherein the crushing chamber includes a fluid introduction mechanism configured to allow liquid to be added during the crushing process.

7. The sealed medication crushing and delivery system of claim 1, further comprising a transparent window in the crusher body to allow visual monitoring of the medication crushing process.

8. A method of using the sealed medication crushing and delivery system of claim 1, the method comprising the steps of:
introducing a solid medication into the sealed crushing chamber;
adding a liquid solvent to the chamber via the syringe-connectable inlet;
sealing the chamber by securing the lid in place;
engaging the motor assembly with the crusher assembly;
activating the motor to pulverize and mix the medication into a liquid suspension;
detaching the motor assembly upon completion of crushing; and
expelling the liquid suspension from the chamber through the discharge port into an enteral tube, using an enteral syringe.

9. A sealed medication crushing and delivery system for enteral administration, the sealed medication crushing and delivery system comprising:
a housing defining a crushing chamber with an input port configured to receive medication and liquid;
a motor-driven crushing mechanism disposed within the chamber and configured to pulverize medication;
a motor unit operably coupled to the crushing mechanism, the motor unit configured to provide rotational power to the crushing mechanism;
an output port coupled to the chamber, the output port configured to connect to an enteral tube for direct administration of the crushed medication; and
a safety interlock mechanism ensuring that the crushing mechanism operates only when the device is properly engaged.

10. The sealed medication crushing and delivery system of claim 9, wherein the motor unit operates at a predefined speed and torque to ensure efficient pulverization of solid medications.

11. The sealed medication crushing and delivery system of claim 9, further comprising a vented lid with a pressure-equalizing valve to prevent excessive internal pressure buildup during crushing.

12. The sealed medication crushing and delivery system of claim 9, wherein the output port includes a valve to prevent leakage and contamination.

13. The sealed medication crushing and delivery system of claim 9, further comprising a detachable lid locking mechanism to ensure a secure seal between the lid and the crushing chamber.

14. The sealed medication crushing and delivery system of claim 9, wherein the crushing mechanism comprises a grinding burr, a set of impact blades, or a milling disc.

15. The sealed medication crushing and delivery system of claim 9, wherein the safety interlock mechanism includes a magnetic or mechanical sensor to detect proper engagement before operation.

16. A sealed medication crushing and delivery system for enteral administration, the sealed medication crushing and delivery system comprising:
a crusher assembly having a sealed containment chamber with an entry port for introducing solid medication and a discharge port for delivering a liquid mixture of the medication;
a motor-driven rotatable blade assembly disposed within the containment chamber and configured to crush and mix the medication;
a motorized base removably attachable to the containment chamber and configured to drive the rotatable blade assembly;
a fluid coupling system configured to allow the introduction of a liquid through the entry port while maintaining a closed environment;
a locking mechanism configured to secure the chamber to the motorized base and prevent operation unless properly engaged;
a manually operable plunger configured to expel the medication mixture through the discharge port.

17. The sealed medication crushing and delivery system of claim 16, further comprising a liquid injection port configured to introduce water or a dissolving solution to aid in medication preparation.

18. The sealed medication crushing and delivery system of claim 16, wherein the motorized base includes a light emitting diode (LED) status indicator to display operation and battery level.

19. The sealed medication crushing and delivery system of claim 16, wherein the discharge port includes a filtering mechanism to ensure uniform consistency of the crushed medication.

20. The sealed medication crushing and delivery system of claim 16, further comprising a manually operable plunger configured to expel the medication mixture through the discharge port.

21. A sealed medication crushing and delivery system for enteral administration, the sealed medication crushing and delivery system comprising:
a first main body comprising:
an entry port for introducing fluid into a sealed crushing chamber; and
a first thread integrally formed around the perimeter of the first main body;
the second main body, configured to move axially relative to a first main body, the second main body comprising:
a tablet support surface for securing a solid medication during crushing;
a discharge port positioned at a lower portion of the second main body for direct expulsion of crushed medication; and
a second thread integrally formed around the perimeter of the second main body and configured to engage with the first thread of the first main body to define the sealed crushing chamber;
a sealing ring disposed between the first and second main bodies, configured to prevent leakage and airborne particulate release;
wherein the axial movement, by rotating the first main body relative to the second main body, applies mechanical crushing force to the solid medication within the sealed crushing chamber, reducing it to a fine powder;
wherein the fluid introduced through the entry port facilitates dispersion and suspension of the crushed medication, forming a liquid mixture suitable for enteral administration; and
wherein the discharge port is configured for direct attachment to an enteral syringe or an enteral tube to allow direct medication administration without intermediate handling.

22. The sealed medication crushing and delivery system of claim 21, wherein at least one crushing ridge is formed within the first main body and configured to engage with the tablet support surface to further facilitate comminution of the solid medication.

23. The sealed medication crushing and delivery system of claim 22, wherein the at least one crushing ridge, within the first main body, includes at least one blunt bar, and the tablet support surface comprises at least one bar-shaped recess, ensuring effective interlocking and medication fragmentation.
